(19) United States
(12) Patent Application Publication
(10) Pub. No.: US 2025/0201725 A1
(43) Pub. Date: Jun. 19, 2025

(54) FINGERPRINT SENSOR PACKAGE, FINGERPRINT SENSOR PACKAGE STACKED STRUCTURE AND FINGERPRINT AUTHENTICATION CARD

(71) Applicant: SAMSUNG ELECTRONICS CO., LTD., Suwon-si (KR)

(72) Inventors: Jaehyun LIM, Suwon-si (KR); Yoon-Seok Seo, Suwon-si (KR); Youngjun Yoon, Suwon-si (KR); Yechung Chung, Suwon-si (KR)

(73) Assignee: SAMSUNG ELECTRONICS CO., LTD., Suwon-si (KR)

(21) Appl. No.: 18/790,731

(22) Filed: Jul. 31, 2024

(30) Foreign Application Priority Data
Dec. 19, 2023 (KR) 10-2023-0185970

(51) Int. Cl. H01L 23/538; G06F 21/32; H01L 23/00; H01L 23/31; H01L 25/16

(52) U.S. Cl. CPC H01L 23/5388; G06F 21/32; H01L 25/16; H01L 23/3107; H01L 24/16; H01L 2224/16225

(57) ABSTRACT

A fingerprint sensor package includes a substrate, a controller chip on the substrate, and a molding material molding the controller chip. The substrate includes an insulating layer, a first conductive pattern layer, a second conductive pattern layer spaced apart from the first conductive pattern layer by the insulating layer, and a protective layer at least partially covering the second conductive pattern layer. The second conductive pattern layer includes a first test pad electrically coupled with a first sensing pattern of the first conductive pattern layer, a second sensing pattern intersecting the first sensing pattern on a plane, and a second test pad electrically coupled with the second sensing pattern. The first conductive pattern layer is at a level between the second conductive pattern layer and the controller chip. The first test pad and the second test pad are at least partially exposed through openings of the protective layer.

### CROSS-REFERENCE TO RELATED APPLICATIONS

This application claims benefit of priority under 35 U.S.C. § 119 to Korean Patent Application No. 10-2023-0185970, filed on Dec. 19, 2023, in the Korean Intellectual Property Office, the disclosure of which is incorporated by reference herein in its entirety.

### BACKGROUND

### 1. Field

The present disclosure relates generally to fingerprint sensors, and more particularly, to a fingerprint sensor package, a fingerprint sensor package stacked structure, and a fingerprint authentication card.

### 2. Description of Related Art

A fingerprint authentication card may provide high security protection against personal identification number (PIN) number leakage due to the fingerprint authentication card being powered by wireless charging and performing an fingerprint authentication process only when the fingerprint authentication card comes into contact (or near proximity) with a radio frequency (RF) reader. Some fingerprint authentication cards may include a printed circuit board (PCB) type of fingerprint authentication card that may use changes in capacitance to perform the fingerprint authentication process. In such types of fingerprint authentication cards, the fingerprint sensor patterns may be embedded in a protective layer and/or an insulating layer of the PCB. However, the embedded fingerprint sensor patterns negatively affect the ability to perform electrical inspections on the PCBs, and as such, reliability of the fingerprint authentication cards may be impacted.

### SUMMARY

One or more example embodiments of the present disclosure provide a fingerprint sensor package capable of electrical testing, a fingerprint sensor package including the same, and a fingerprint authentication card.

According to an aspect of the present disclosure, a fingerprint sensor package includes a first substrate, a controller chip on the first substrate, and a molding material molding the controller chip. The first substrate includes a first insulating layer, a first conductive pattern layer, a second conductive pattern layer spaced apart from the first conductive pattern layer by the first insulating layer, and a first protective layer at least partially covering the second conductive pattern layer. The first conductive pattern layer includes a first sensing pattern. The second conductive pattern layer includes a first test pad electrically coupled with the first sensing pattern, a second sensing pattern intersecting the first sensing pattern on a plane, and a second test pad electrically coupled with the second sensing pattern. The first conductive pattern layer is at a level between the second conductive pattern layer and the controller chip. The first test pad and the second test pad are at least partially exposed through one or more first openings of the first protective layer.

According to an aspect of the present disclosure, a fingerprint sensor package stacked structure includes a fingerprint sensor package, and a second substrate on which the fingerprint sensor package is disposed and including a through hole. The fingerprint sensor package includes a first substrate including a central region, a peripheral region at least partially surrounding the central region, a first insulating layer, a first conductive pattern layer, a second conductive pattern layer spaced apart from the first conductive pattern layer by the first insulating layer, and a protective layer at least partially covering the second conductive pattern layer, a controller chip on the central region of the first substrate, and a molding material molding the controller chip. The central region of the first substrate at least partially disposed on the through hole. The first conductive pattern layer includes a first sensing pattern. The second conductive pattern layer includes a first test pad electrically coupled with the first sensing pattern, a second sensing pattern intersecting the first sensing pattern on a plane, and a second test pad electrically coupled to the second sensing pattern. The first sensing pattern and the second sensing pattern are in the central region of the first substrate. The first test pad and the second test pad are in the peripheral region of the first substrate and face the second substrate. The first test pad and the second test pad are at least partially exposed through one or more openings of the protective layer.

According to an aspect of the present disclosure, a fingerprint authentication card includes a card body having a groove, and a fingerprint sensor package, at least a portion of the fingerprint sensor package being within the groove. The fingerprint sensor package includes a substrate including an insulating layer, a first conductive pattern layer, a second conductive pattern layer spaced apart from the first conductive pattern layer by the insulating layer, and a protective layer at least partially covering the second conductive pattern layer, a controller chip on a first surface of the substrate, and a molding material molding the controller chip. The first conductive pattern layer includes a first sensing pattern. The second conductive pattern layer includes a first connection pattern electrically coupled with the first sensing pattern, a second sensing pattern intersecting the first sensing pattern on a plane, and a second connection pattern electrically coupled with the second sensing pattern. The first connection pattern and the second connection pattern are at least partially exposed to side surfaces of the substrate.

Additional aspects may be set forth in part in the description which follows and, in part, may be apparent from the description, and/or may be learned by practice of the presented embodiments.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 is a schematic top view of a fingerprint authentication card, according to an embodiment;

FIG. 2 is a cross-sectional view in the Y direction of a fingerprint sensor package, according to an embodiment;

FIG. 3 is a cross-sectional view in the X direction of a fingerprint sensor package, according to an embodiment;

FIGS. 4 and 5 are top plan views showing a schematic layout of a first conductive pattern layer and a second conductive pattern layer of a fingerprint sensor package, according to an embodiment;

FIG. 6 is a cross-sectional view in the Y direction of a fingerprint sensor package stacked structure including a fingerprint sensor package, according to an embodiment;

FIG. 7 is a cross-sectional view depicting the punching process of the fingerprint sensor package stacked structure shown in FIG. 6, according to an embodiment;

FIG. 8 is a cross-sectional view in the Y direction of the fingerprint sensor package punched along a punching line, according to an embodiment;

FIG. 9 is a cross-sectional view in the X direction of a fingerprint sensor package punched along a punching line, according to an embodiment;

FIG. 10 is a cross-sectional view illustrating the joining process between the fingerprint sensor package and a card body, according to an embodiment;

FIG. 11 is a cross-sectional view in the Y direction of a fingerprint authentication card, according to an embodiment; and

FIG. 12 is a cross-sectional view in the Y direction of a fingerprint authentication card, according to an embodiment.

### DETAILED DESCRIPTION

The present disclosure is described with reference to the accompanying drawings, in which embodiments of the present disclosure are shown. As those skilled in the art may realize, the described embodiments may be modified in various different ways without departing from the spirit and/or scope of the present disclosure.

The drawings and the description are to be regarded as illustrative in nature and not restrictive. That is, the present disclosure is not limited to the embodiments illustrated in the drawings and described in the description. With regard to the description of the drawings, similar reference numerals may designate similar or related elements throughout the present disclosure.

Size and thickness of each constituent element in the drawings may be arbitrarily illustrated for better understanding and ease of description, and as such, the following embodiments may not be limited thereto. In the drawings, the thickness of layers, films, panels, regions, and the like, may be exaggerated for clarity and/or for ease of description.

As used herein, the term “coupled” may indicate that the elements are “directly coupled”, but may also indicate that the elements may be “indirectly coupled” with another element in between. Such an interpretation may apply when the term “couple” indicates that elements are “physically coupled”, but also when the elements are “electrically coupled.”

In addition, unless explicitly described to the contrary, the word “comprise”, and variations such as “comprises” or “comprising”, is to be understood to imply the inclusion of stated elements but not the exclusion of any other elements.

It is to be understood that when an element such as, but not limited to, a layer, a film, a region, or a substrate is referred to as being “on” another element, the element may be directly on the other element or intervening elements may also be present. Alternatively, when an element is referred to as being “directly on” another element, there may be no intervening elements present. In addition, when an element is referred to as being “on” or “above” a reference element, the element may be positioned above or below the reference element, and the element may not be necessarily referred to as being positioned “on” or “above” in a direction opposite to gravity.

As used herein, the phrase “on a plane” may refer to a view from a position above the object (e.g., from the top), and the phrase “on a cross-section” may refer to a view of a cross-section of the object which is vertically cut from the side.

In addition, throughout the present disclosure, although terms of “first,” “second,” and the like may be used to explain various constituent elements, the constituent elements may not be limited to such terms. These terms may only be used to distinguish one constituent element from another constituent element. Accordingly, a configuration referred to as the first constituent element in a certain part of the present disclosure may also be referred to as the second constituent element in other parts of the present disclosure.

As used herein, singular forms may be intended to include the plural forms unless the context clearly indicates otherwise. For example, “insulating layer” may be used to mean not just a single insulating layer, but a plurality of insulating layers, such as two (2) layers, three (3) layers, or more than three (3) layers.

In addition, throughout the present disclosure, references to one surface and the other surface may be intended to distinguish different surfaces from each other, and may not be necessarily intended to limit the surfaces to a specific surface.

Accordingly, the side referred to as one surface in a specific part of the present disclosure may be referred to as the other surface in other parts of the present disclosure.

As used herein, when an element or layer is referred to as “covering”, “overlapping”, or “surrounding” another element or layer, the element or layer may cover at least a portion of the other element or layer, where the portion may include a fraction of the other element or may include an entirety of the other element. Similarly, when an element or layer is referred to as “penetrating” another element or layer, the element or layer may penetrate at least a portion of the other element or layer, where the portion may include a fraction of the other element or may include an entire dimension (e.g., length, width, depth) of the other element.

As used herein, each of such phrases as “A or B,” “at least one of A and B,” “at least one of A or B,” “A, B, or C,” “at least one of A, B, and C,” and “at least one of A, B, or C,” may include any one of possible combinations of the items enumerated together in a corresponding one of the phrases.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

Hereinafter, various embodiments of the present disclosure are described with reference to the accompanying drawings.

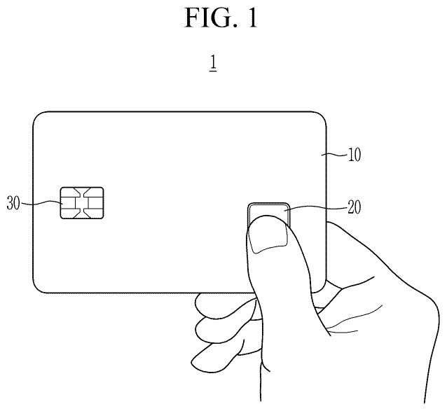

FIG. 1 is a schematic top view of a fingerprint authentication card, according to an embodiment.

A fingerprint authentication card 1 may include a card body 10, a fingerprint sensor package 20, and a security chip 30. The card body 10 of the fingerprint authentication card 1 may be formed of plastic, for example. However, the present disclosure is not limited in this regard, and the fingerprint authentication card 1 may be formed of other materials and/or material combinations.

The fingerprint sensor package 20 may be configured to recognize (e.g., identify) a user's fingerprint when the user's fingerprint is in contact with the fingerprint sensor package 20, compare the recognized fingerprint with a registered fingerprint, and determine whether the recognized fingerprint matches the registered fingerprint. Additionally, the security chip 30 may store encrypted financial information. In such an example, if or when the fingerprint recognized through the fingerprint sensor package 20 matches the registered fingerprint, the security chip 30 may grant payment authority to the user. By performing the fingerprint authentication process described above, the fingerprint authentication card 1 may confirm the user's identity, grant payment authority to the identified user, and potentially address issues such as, but not limited to, theft and forgery.

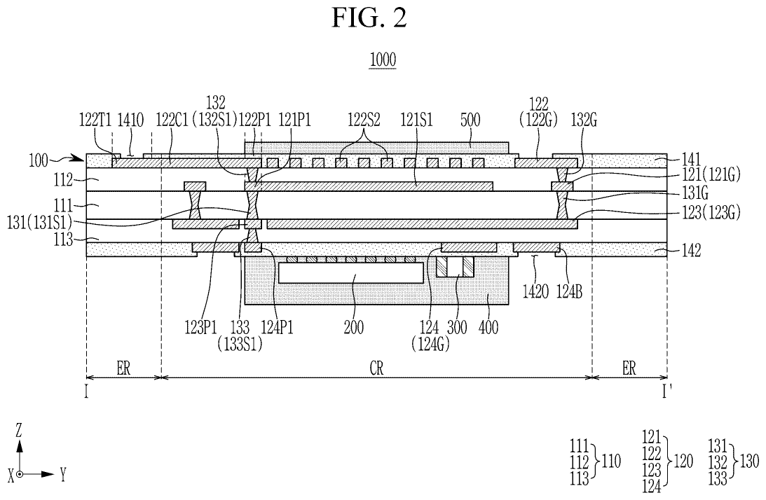

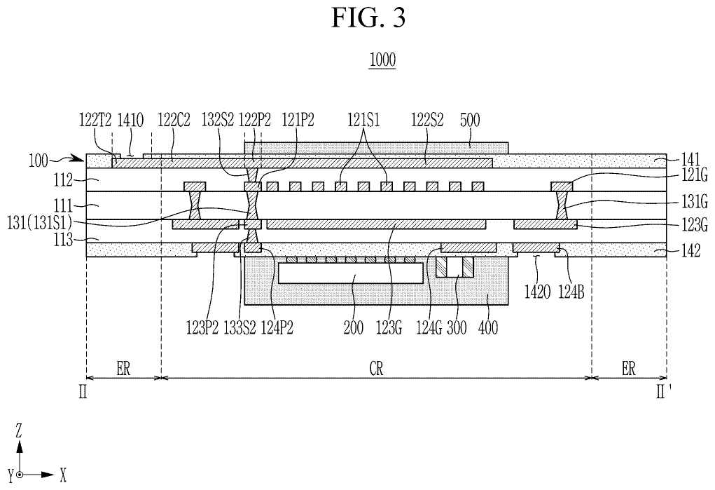

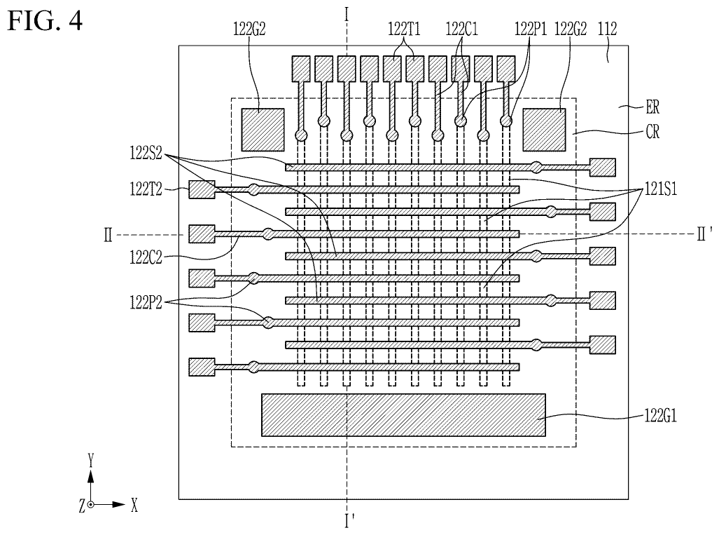

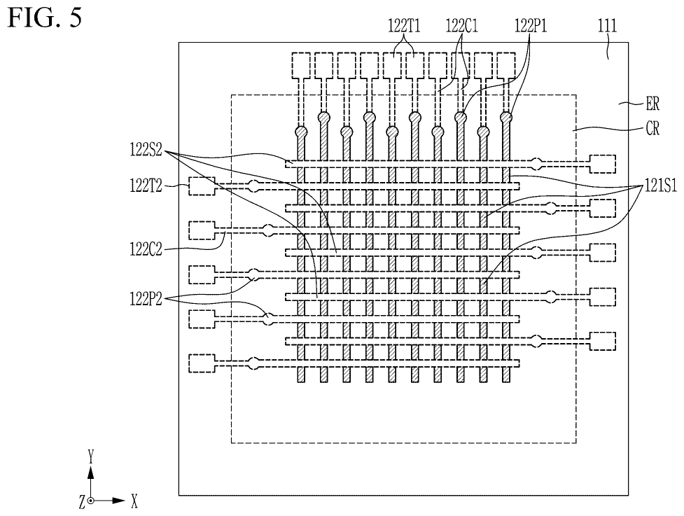

FIG. 2 is a cross-sectional view in the Y direction of a fingerprint sensor package, according to an embodiment. FIG. 3 is a cross-sectional view in the X direction of a fingerprint sensor package, according to an embodiment. FIGS. 4 and 5 are top plan views showing a schematic layout of a first conductive pattern layer and a second conductive pattern layer of a fingerprint sensor package, according to an embodiment.

Referring to FIGS. 2 to 5, a fingerprint sensor package 1000 may include a first substrate 100, a controller chip 200, and a passive component 300 disposed on a first surface of the first substrate 100. The fingerprint sensor package 1000 may further include a molding material 400 for molding the controller chip 200, a passive component 300, and a coating layer 500 disposed on a second surface of the first substrate 100, which may be opposite to the first surface of the first substrate 100.

The first substrate 100 may have a central region CR and a peripheral region ER surrounding the central region CR. The central region CR and the peripheral region ER may each have an approximately quadrangle shape, such as, but not limited to, a rectangle or square.

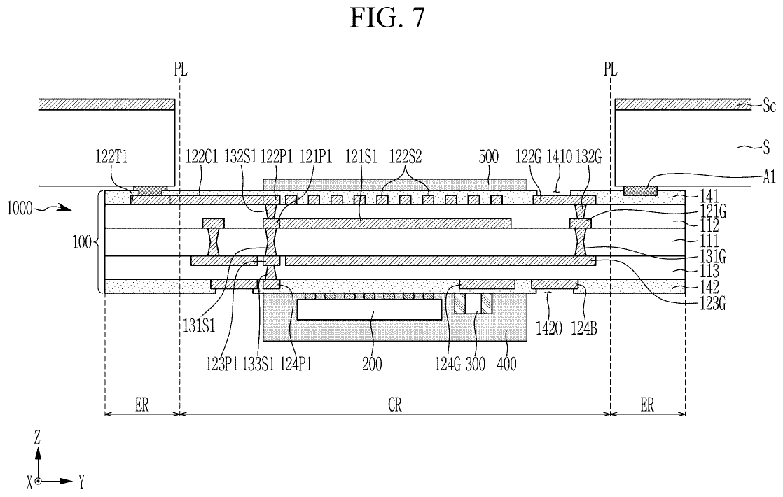

In an embodiment, the peripheral region ER may be and/or may include a region that may be removed after an electrical inspection of the fingerprint sensor package 1000 and a punching process is performed, as described with reference to FIGS. 7 to 9. In such an embodiment, a first test pad 122T1 and a second test pad 122T2 for electrical inspection of the fingerprint sensor package 1000 may be disposed in the peripheral region ER.

Alternatively or additionally, the central region CR may be and/or may include the region that remains after the punching process is performed, and may include configurations such as, but not limited to, the controller chip 200, the passive component 300, a first sensing pattern 121S1, a second sensing pattern 122S2, a plurality of pads (e.g., a first pad 121P1, a second pad 121P2, a third pad 122P1, a fourth pad 122P2, a fifth pad 123P1, a sixth pad 123P2, a seventh pad 124P1, and an eighth pad 124P2), and a plurality of ground patterns (e.g., a first ground pattern 121G, a second ground pattern 122G, a third ground pattern 123G, and a fourth ground pattern 124G), for functioning as the fingerprint sensor package 1000. As used herein, the central region CR and the peripheral region ER may be regions that are referred to in the present disclosure for better understanding and ease of description. However, the central region CR and/or the peripheral region ER may not be regions that may be physically separated from each other by boundaries on the fingerprint sensor package 1000.

The first substrate 100 may include a plurality of insulating layers 110, a plurality of conductive pattern layers 120, a plurality of vias 130 (e.g., a first via 131, a second via 132, and a third via 133), and protective layers (e.g., a first protective layer 141 and a second protective layer 142).

For example, the first substrate 100 may include a first insulating layer 111, a first conductive pattern layer 121 disposed on a first surface of the first insulating layer 111, a second insulating layer 112 disposed on the first surface of the first insulating layer 111 and covering the first conductive pattern layer 121, a second conductive pattern layer 122 disposed on the second insulating layer 112, a third conductive pattern layer 123 disposed on a second surface of the first insulating layer 111, a third insulating layer 113 disposed on the second surface of the first insulating layer 111 and covering the third conductive pattern layer 123, and a fourth conductive pattern layer 124 disposed on the third insulating layer 113.

Further, the first substrate 100 may include the first vias 131 connecting the first conductive pattern layer 121 and the third conductive pattern layer 123 through the first insulating layer 111, the second vias 132 connecting the first conductive pattern layer 121 and the second conductive pattern layer 122 through the second insulating layer 112, and the third vias 133 connecting the second conductive pattern layer 122 and the fourth conductive pattern layer 124 through the third insulating layer 113. That is, the plurality of vias 130 may connect a pattern and/or pad of a conductive pattern layer with a pattern and/or pad of another conductive pattern layer.

The first substrate 100 may further include the first protective layer 141 disposed on the second insulating layer 112 and covering the second conductive pattern layer 122, and the second protective layer 142 disposed on the third insulating layer 113 and covering the fourth conductive pattern layer 124. In an embodiment, the first protective layer 141 may include one or more first openings 141O exposing the first test pad 122T1, the second test pad 122T2, and the second ground pattern 122G. Alternatively or additionally, the second protective layer 142 may include one or more openings second 142O exposing a connection pad 124B.

The thickness of the first insulating layer 111 may be thicker (e.g., greater) than the thickness of the second insulating layer 112 and the third insulating layer 113, and may function as a core insulating layer to maintain the rigidity of the first substrate 100. However, the present disclosure is not limited thereto, and the thickness of each of the plurality of insulating layers 110 may be adjusted according to design constraints.

The material of the first insulating layer 111 may be and/or may include an insulating material, for example, thermosetting resin such as, but not limited to, a polyimide, thermosetting resin such as, but not limited to, epoxy, prepreg, Ajinomoto build-up film (ABF), or the like.

The plurality of conductive pattern layers 120 may be spaced apart by the insulating layer 110 disposed between the plurality of conductive pattern layers 120 and may be insulated from each other through the insulating layer 110. For example, the first conductive pattern layer 121 and the third conductive pattern layer 123 may be spaced apart by the first insulating layer 111, the first conductive pattern layer 121 and the second conductive pattern layer 122 may be spaced apart by the second insulating layer 112, and the third conductive pattern layer 123 and the fourth conductive pattern layer 124 may be spaced apart by the third insulating layer 113.

The first conductive pattern layer 121 may include the first sensing pattern 121S1, the first and second pads 121P1 and 121P2, and the first ground pattern 121G.

The second conductive pattern layer 122 may include the second sensing pattern 122S2, the third and fourth pads 122P1 and 122P2, the first test pad 122T1, the second test pad 122T2, a first connection pattern 122C1, a second connection pattern 122C2, and a second ground pattern 122G.

The third conductive pattern layer 123 may include fifth and sixth pads 123P1 and 123P2, and a third ground pattern 123G.

The fourth conductive pattern layer 124 may include seventh and eighth pads 124P1 and 124P2, a fourth ground pattern 124G, and the connection pad 124B for electrically connecting the fingerprint sensor package 1000 to other components. The connection pad 124B may be electrically connected to a power pattern, signal pattern, ground pattern, or the like, as needed.

The second conductive pattern layer 122 may be an outermost conductive pattern layer positioned on the opposite surface of the first substrate 100 where the controller chip 200 is disposed. The first conductive pattern layer 121, the third conductive pattern layer 123, and the fourth conductive pattern layer 124 may be positioned at a level between the second conductive pattern layer 122 and the controller chip 200.

Each conductive pattern layer 120 may further include components other than those listed above, and may include, but not limited to, for example, a power pattern, a signal pattern, a wiring pattern, or the like. Alternatively or additionally, the patterns and pads included in each conductive pattern layer 120 may be positioned at the same level and have the same thickness.

The first sensing pattern 121S1, the second sensing pattern 122S2, first to eighth pads 121P1 to 124P2, and first to fourth ground patterns 121G to 124G may be disposed in the central region CR of the first substrate 100.

The first test pad 122T1 and the second test pad 122T2 may be disposed in the peripheral region ER of the first substrate 100.

The first connection pattern 122C1 and the second connection pattern 122C2 may be disposed to extend from the central region CR of the first substrate 100 to the peripheral region ER.

Referring to FIGS. 4 and 5, the first sensing pattern 121S1 and the second sensing pattern 122S2 may intersect on a plane. As shown in the drawings, the first sensing pattern 121S1 may extend in the Y direction, and the second sensing pattern 122S2 may extend in the X direction that intersects the Y direction on a plane. The first sensing pattern 121S1 may be a plurality of first sensing patterns 121S1 spaced apart from each other in the X direction, and the second sensing pattern 122S2 may be a plurality of second sensing patterns 121S2 spaced apart from each other in the Y direction.

The region where the first sensing pattern 121S1 and the second sensing pattern 122S2 overlap on a plane may form a pixel capable of a sensing function. When the user's fingerprint contacts the coating layer 500 of the first substrate 100, the capacitance value between the first sensing pattern 121S1 and the second sensing pattern 122S2 may change in each pixel. The controller chip 200 may recognize the user's fingerprint through the changed capacitance values and, if necessary, may image the user's fingerprint in gray scale.

The first sensing pattern 121S1 may be electrically connected to the first test pad 122T1 sequentially via the first pad 121P1, a third via 132S1, the third pad 122P1, and the first connection pattern 122C1.

Additionally, the second sensing pattern 122S2 may be electrically connected to the second test pad 122T2 sequentially via the fourth pad 122P2 and the second connection pattern 122C2.

The width of the first sensing pattern 121S1 and the second sensing pattern 122S2 may be narrower (e.g., less) than the width of each of the first pad 121P1, the second pad 121P2, the third pad 122P1, and the fourth pad 122P2. The width of the first sensing pattern 121S1 may refer to a width in the X direction perpendicular to the extension direction of the first sensing pattern 121S1, and the width of the second sensing pattern 122S2 may refer to a width in the Y direction perpendicular to the extension direction of the second sensing pattern 122S2.

The first pad 121P1 included in the first conductive pattern layer 121 may extend from the first sensing pattern 121S1 and may contact a first via 131S1 and a third via 132S1. The second pad 121P2 may be electrically connected to the second sensing pattern 122S2 through a fourth via 132S2 and may be in contact with a second via 131S2 and a fourth via 132S2.

The third pad 122P1 included in the second conductive pattern layer 122 may be in contact with the third via 132S1 and may be electrically connected to the first sensing pattern 121S1 through the third via 132S1. The fourth pad 122P2 may extend from the second sensing pattern 122S2 and may contact the fourth via 132S2.

The third pad 122P1 may be disposed only at one end of the central region CR of the first substrate 100 in the Y direction, and a space for arranging the ground pattern 122G1 may be provided at the end opposite to the end where the third pad 122P1 may be disposed. The first pad 121P1 connected to the third pad 122P1 and the third via 132S1 may also be disposed only at one end of the central region CR of the first substrate 100 in the Y direction. Alternatively or additionally, the fourth pad 122P2 may be alternately disposed at both ends of the central region CR of the first substrate 100 in the X direction.

However, the present disclosure is not limited thereto. For example, in an embodiment, the third pad 122P1 may be disposed at both ends in the Y direction of the central region CR of the first substrate 100, and the fourth pad 122P2 may be disposed at only one end in the X direction of the central region CR of the first substrate 100.

The fifth pad 123P1 included in the third conductive pattern layer 123 may be electrically connected to the first sensing pattern 121S1 through the first via 131S1, and may be in contact with the first via 131S1 and a fifth via 133S1. A sixth pad 123P2 may be electrically connected to the second sensing pattern 122S2 through the second via 131S2 and the fourth via 132S2, and may be in contact with the second via 131S2 and the sixth via 133S2.

A seventh pad 124P1 included in the fourth conductive pattern layer 124 may be in contact with the fifth via 133S1, and may be electrically connected to the first sensing pattern 121S1. An eighth pad 124P2 may be in contact with the sixth via 133S2, and may be electrically connected to the second sensing pattern 122S2 through the sixth via 133S2, the second via 131S2 and the fourth via 132S2.

The first test pad 122T1 may be electrically connected to the first sensing pattern 121S1. The first test pad 122T1 may be electrically connected to the first sensing pattern 121S1 sequentially via the first connection pattern 122C1, the third pad 122P1, the third via 132S1, and the first pad 121P1.

Additionally, the second test pad 122T2 may be electrically connected to the second sensing pattern 122S2. The second test pad 122T2 may be electrically connected to the second sensing pattern 122S2 sequentially via the second connection pattern 122C2 and the fourth pad 122P2.

The first test pad 122T1 may extend in the Y direction from the first sensing pattern 121S1 on a plane. The first test pad 122T1 may be and/or may include a plurality of first test pads 122T1 connected to each of a plurality of first sensing patterns 121S1, and the plurality of first test pads 122T1 may be spaced apart to each other in the X direction.

The second test pad 122T2 may extend from the second sensing pattern 122S2 in the X direction. The second test pad 122T2 may be and/or may include a plurality of second test pads 122T2 connected to each of a plurality of second sensing patterns 122S2, and the plurality of second test pads 122T2 may be spaced apart from each other in the Y direction.

Similarly to the third pad 122P1, the plurality of first test pads 122T1 may be disposed only at one end of the peripheral region ER of the first substrate 100 in the Y direction, and a space for arranging the ground pattern 122G1 may be provided at the end opposite to the end where the first test pad 122T1 is disposed. Alternatively, similarly to the fourth pad 122P2, the plurality of second test pads 122T2 may be alternately disposed at both ends of the peripheral region ER of the first substrate 100 in the X direction.

The first connection pattern 122C1 may connect the third pad 122P1 and the first test pad 122T1. The first connection pattern 122C1 may be disposed to extend from the central region CR of the first substrate 100 to the peripheral region ER. The first connection pattern 122C1 may be and/or may include a plurality of first connection patterns 122C1 for one-to-one connections of the plurality of first sensing patterns 121S1 and the plurality of first test pads 122T1. The plurality of first connection patterns 122C1 may be spaced apart from each other in the X direction.

The second connection pattern 122C2 may connect the fourth pad 122P2 and the second test pad 122T2. The second connection pattern 122C2 may be disposed to extend from the central region CR of the first substrate 100 to the peripheral region ER. The second connection pattern 122C2 may be and/or may include a plurality of second connection patterns 122C2 for one-to-one connections of the plurality of second sensing patterns 122S2 and the plurality of second test pads 122T2. The plurality of second connection patterns 122C2 may be spaced apart from each other in the Y direction.

The widths of the first connection pattern 122C1 and the second connection pattern 122C2 may be narrower (e.g., less) than the widths of each of the first pad 121P1, the second pad 121P2, the third pad 122P1, and the fourth pad 122P2. The width of the first connection pattern 122C1 may refer to a width in the X direction that may be perpendicular to an extension direction of the first connection pattern 122C1, and the width of a second connection pattern 121C2 may refer to a width in the Y direction that may be perpendicular to an extension direction of the second connection pattern 121C2.

However, the shape of the first connection pattern 122C1 and the second connection pattern 122C2 are not limited in this regard, and may have a shape such as, but not limited to, a rectangle, a square, or a circle.

In an embodiment, the plurality of first connection patterns 122C1 may be disposed only at one end of the peripheral region ER of the first substrate 100 in the Y direction, and the plurality of second connection patterns 122C2 may be alternately disposed at both ends of the peripheral region ER in the X direction of the first substrate 100. However, the present disclosure is not limited thereto.

The first to fourth ground patterns 121G to 124G may perform a noise shielding function and may be electrically connected to each other through vias (e.g., a seventh via 131G, an eighth via 132G, and a ninth via 133G).

The first ground pattern 121G may be and/or may include a plurality of first ground patterns 121G. The first ground pattern 121G may be and/or may include the first ground pattern 121G1 spaced apart from the first test pad 122T1 in the Y direction, and the second sensing pattern 122S2 may be disposed between the first ground pattern 121G1 and the first test pad 122T1. In an embodiment, the first ground pattern 121G may include a first ground pattern 121G2 disposed in at least one of the corner regions of the central region CR of the first substrate 100. Through the above-described structure, the first test pad 122T1 and the second test pad 122T2 may be disposed in the peripheral region ER of the first substrate 100, and the first ground patterns 121G may also be efficiently disposed.

The second ground pattern 122G may be disposed at an edge region of the central region CR of the first substrate 100 to surround the second sensing pattern 122S2. The second ground pattern 122G may be singular or plural. That is, the second ground pattern 122G may be and/or may include a single ground pattern or a plurality of ground patterns.

The third ground pattern 123G may overlap in the Z direction with at least one of the first sensing pattern 121S1, the second sensing pattern 122S2, and the controller chip 200, and may effectively shield noise between the first and second sensing patterns 121S1 and 122S2 and the controller chip 200.

The first via 131 may penetrate the first insulating layer 111 in the central region CR of the first substrate 100. The first via 131 may be and/or may include the first via 131S1 electrically connecting the first pad 121P1 and the fifth pad 123P1 connected to the first sensing pattern 121S1, the second via 131S2 electrically connecting the second pad 121P2 and the sixth pad 123P2 connected to the second sensing pattern 122S2, respectively, and a seventh via 131G electrically connecting the first ground pattern 121G and the third ground pattern 123G.

The second via 132 may penetrate the second insulating layer 112 in the central region CR of the first substrate 100. The second via 132 may be and/or may include the third via 132S1 electrically connecting the first pad 121P1 and the third pad 122P1 connected to the first sensing pattern 121S1, the fourth via 132S2 electrically connecting the second pad 121P2 and the fourth pad 122P2 connected to the second sensing pattern 122S2, and an eighth via 132G electrically connecting the first ground pattern 121G and the second ground pattern 122G.

In an embodiment, the third via 132S1 may electrically connect the first sensing pattern 121S1 and the first test pad 122T1 disposed on different layers, and an electrical test between the first sensing pattern 121S1 and the components connected thereto may be possible through the first test pad 122T1. The electrical test may be and/or may include, for example, a resistance-type electrical test. In such an example, the third via 132S1 may be in contact with each of the first pad 121P1 and the third pad 122P1, respectively, to electrically connect the first test pad 122T1 connected to the first pad 121P1 and the first sensing pattern 121S1 connected to the third pad 122P1.

The third via 133 may penetrate the third insulating layer 113 in the central region CR of the first substrate 100. The third via 133 may include the third via 132S1 electrically connecting the fifth pad 123P1 and the seventh pad 124P1 respectively connected to the first sensing pattern 121S1, the sixth via 133S2 electrically connecting the sixth pad 123P2 and the eighth pad 124P2 respectively connected to the second sensing pattern 122S2, and a ninth via 133G electrically connecting the third ground pattern 123G and the fourth ground pattern 124G.

Continuing to refer to FIGS. 2 to 5, only some of the seventh to ninth vias 131G to 133G connecting the first to fourth ground patterns 121G to 124G may be shown. However, the present disclosure is not limited in this regard, and the fingerprint sensor package may include fewer or more vias than depicted in the accompanying drawings.

In an embodiment, conductive materials may be used as materials for the conductive pattern layer 120 and the via 130, such as, but not limited to, aluminum (Al), copper (Cu), gold (Au), silver (Ag), platinum (Pt), tin (Sn), chromium (Cr), palladium (Pd), lead (Pb), titanium (Ti), or alloys thereof.

The first protective layer 141 may be disposed on the second insulating layer 112 and may cover the second conductive pattern layer 122. The first protective layer 141 may have one or more openings 141O, and the first test pad 122T1 and the second test pad 122T2 may be exposed through the opening 141O of the first protective layer 141. In an embodiment, the second ground pattern 122G may be exposed through the opening 141O of the first protective layer 141. The first test pad 122T1, the second test pad 122T2 and the second ground pattern 122G may be exposed through a single opening 141O or through different openings 141O among the one or more openings 141O.

The second protective layer 142 may be disposed on the third insulating layer 113 and may cover the fourth conductive pattern layer 124. The second protective layer 142 may have the opening 142O to expose the connection pad 124B.

The first protective layer 141 and the second protective layer 142 may be solder resist, however, the present disclosure is not limited thereto.

The controller chip 200 may be disposed on one surface of the first substrate 100 and in the central region CR of the first substrate 100, and may be electrically connected to the first substrate 100. In an embodiment, the controller chip 200 may recognize (e.g., identify) the user's fingerprint through the changed capacitance value between the first sensing pattern 121S1 and the second sensing pattern 12282.

The controller chip 200 may be mounted on the first substrate 100 using a flip chip method, and a conductive bump connecting the controller chip 200 and the first substrate 100 may be disposed therebetween.

The passive component 300 may be disposed on one surface of the first substrate 100 and in the central region CR of the first substrate 100 to be spaced apart from the controller chip 200. The passive component 300 may be a multi-layer ceramic capacitor (MLCC), however, the present disclosure is not limited thereto.

The molding material 400 may be disposed on the second protective layer 142 to mold the controller chip 200 and the passive component 300 together. The molding material 400 may be disposed inwardly in the center region CR of the first substrate 100, spaced a predetermined distance from the peripheral region ER of the first substrate 100 so as not to cover the exposed connection pad 124B through the opening 142O of the second protective layer 142.

The molding material 400 may be formed of a thermosetting resin such as, but not limited to, epoxy molding compound or epoxy resin. In an embodiment, the molding material 400 may be formed through a known method such as, but not limited to, compression molding or transfer molding.

The coating layer 500 may be disposed on the first protective layer 141 and may be configured to prevent scratches due to the usage environment. The coating layer 500 may be disposed in the central region CR of the first substrate 100 to overlap at least the first sensing pattern 121S1 and the second sensing pattern 12282 on a plane. The coating layer 500 may include coating materials such as, but not limited to, glass, plastic, and the like.

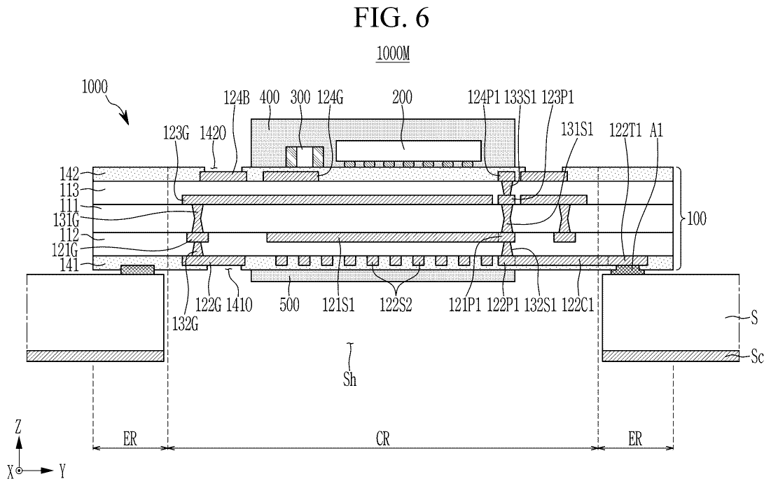

FIG. 6 is a cross-sectional view in the Y direction of a fingerprint sensor package stacked structure including a fingerprint sensor package, according to an embodiment.

A fingerprint sensor package stacked structure 1000M may include the fingerprint sensor package 1000, a second substrate S, and an adhesive member A1, according to the present disclosure.

The fingerprint sensor package stacked structure 1000M may be manufactured for transporting the fingerprint sensor package 1000 and protecting the fingerprint sensor package during transportation.

The fingerprint sensor package 1000 of FIG. 6 may include and/or may be similar in many respects to the fingerprint sensor package 1000 described above with reference to FIGS. 2 to 5, and may include additional features not mentioned above. Furthermore, the first substrate 100, the controller chip 200, the passive component 300, the molding material 400, and a coating layer 500 of FIG. 6 may include and/or may be similar in many respects to the corresponding elements described above with reference to FIGS. 2 to 5, and may include additional features not mentioned above. Consequently, repeated descriptions of these elements described above with reference to FIGS. 2 to 5 may be omitted for the sake of brevity.

The second substrate S may be disposed on a surface of the first substrate 100 opposite to the surface where the controller chip 200 and the passive component 300 are disposed, and may have a through hole Sh. The first test pad 122T1 and the second test pad 122T2 of the first substrate 100 may face the second substrate S.

The central region of the first substrate may be at least partially disposed on the through hole. Therefore, the through hole Sh may overlap the central region CR of the first substrate 100 on a plane, and may prevent contact with the second substrate S from causing the sensing function of the fingerprint sensor package 1000 to operate unnecessarily. Accordingly, the first sensing pattern 121S1 and the second sensing pattern 122S2 positioned in the central region CR of the first substrate 100 may overlap the through hole Sh of the second substrate S on a plane. The first test pad 122T1 and the second test pad 122T2 positioned in the peripheral region ER may overlap the second substrate S on a plane.

The second board S may be a flexible PCB, however, the present disclosure is not limited thereto. A conductive pattern Sc formed of copper or the like may be additionally disposed in a region of the second substrate S that may need rigidity.

The adhesive member A1 may be disposed between the first substrate 100 and the second substrate S. The adhesive member A1 may attach the first substrate 100 and the second substrate S to each other.

The adhesive member A1 may cover the first test pad 122T1 and the second test pad 122T2, may prevent the first test pad 122T1 and the second test pad 122T2 from being exposed to the outside, and may prevent deterioration in reliability of the substrate 100.

Although only a single fingerprint sensor package 1000 is shown in FIG. 6, the present disclosure is not limited in this regard. For example, the second substrate S may have a plurality of through holes Sh, and the fingerprint sensor package stacked structure 1000M may include a plurality of fingerprint sensor packages 1000 respectively disposed on the plurality of through holes Sh.

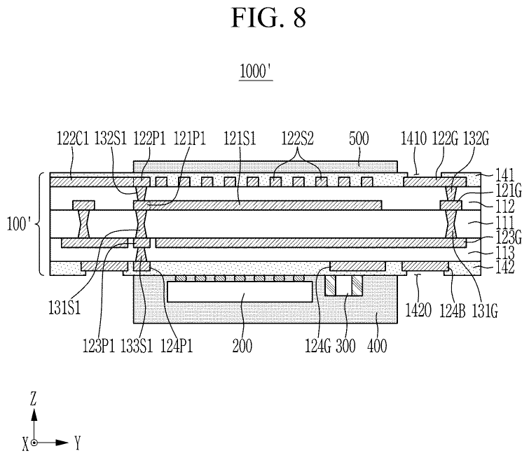

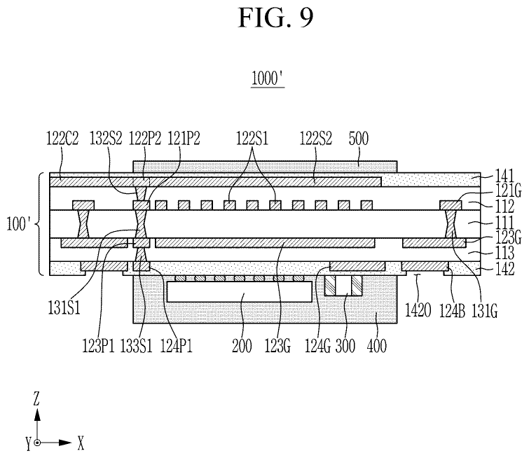

FIG. 7 is a cross-sectional view depicting the punching process of the fingerprint sensor package stacked structure shown in FIG. 6, according to an embodiment. FIG. 8 is a cross-sectional view in the Y direction of the fingerprint sensor package punched along a punching line, according to an embodiment. FIG. 9 is a cross-sectional view in the X direction of a fingerprint sensor package punched along a punching line, according to an embodiment.

Referring to FIGS. 7 to 9, the fingerprint sensor package stacked structure 1000M may be punched along a punching line PL. The punching line PL may coincide with the boundary between the central region CR and the peripheral region ER of the first substrate 100, as shown in FIG. 7. Accordingly, components disposed in the central region CR of the first substrate 100′ after punching may remain in a fingerprint sensor package 1000′ after punching, as shown in FIGS. 8 and 9.

In an embodiment, the first connection pattern 122C1 and the second connection pattern 122C2 may be disposed to extend from the central region CR of the first substrate 100 to the peripheral region ER, and thus after punching, in the fingerprint sensor package 1000′, the first connection pattern 122C1 and the second connection pattern 122C2 may be exposed to the side of a first substrate 100′.

The first connection pattern 122C1 and the second connection pattern 122C2 may be exposed to different sides of the first substrate 100′. The first connection pattern 122C1 may be exposed through one side of the first substrate 100′ in the Y direction. In an embodiment, the second connection pattern 122C2 may be exposed through both sides of the first substrate 100′ in the X direction.

In the present disclosure, for better understanding and ease of description, both the fingerprint sensor package 1000 before punching and the fingerprint sensor package 1000′ after punching may be referred to as fingerprint sensor packages. In addition, both the first substrate 100, included in the fingerprint sensor package 1000 before punching, and the first substrate 100′, included in the fingerprint sensor package 1000′, after punching may be referred to as the first substrate.

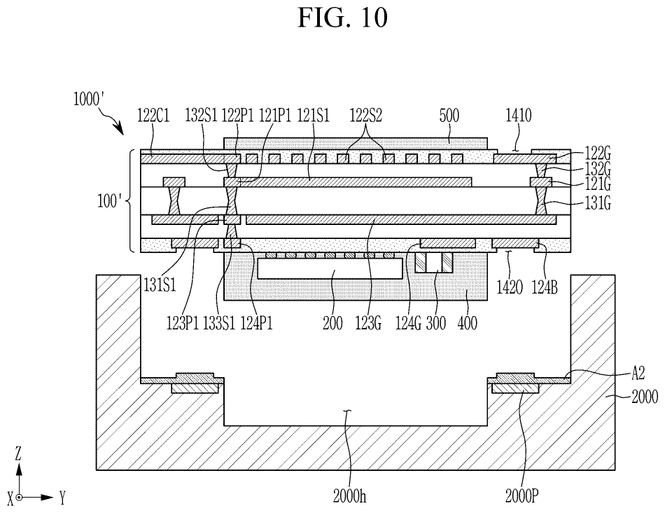

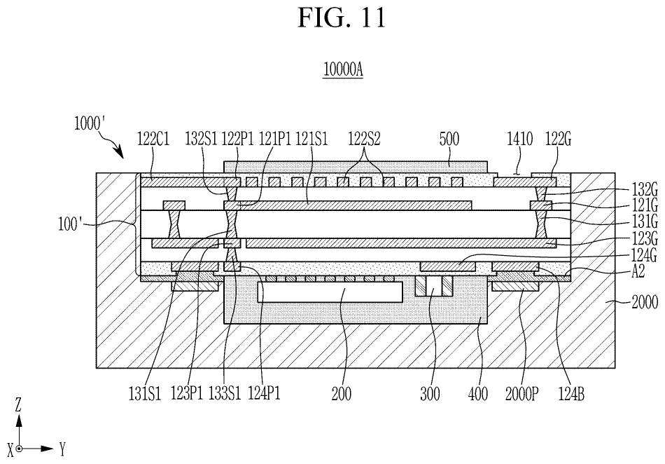

FIG. 10 is a cross-sectional view illustrating the joining process between the fingerprint sensor package and a card body, according to an embodiment. FIG. 11 is a cross-sectional view in the Y direction of a fingerprint authentication card, according to an embodiment.

Referring to FIGS. 10 and 11, a fingerprint authentication card 10000A may include a card body 2000 and a fingerprint sensor package 1000, according to the present disclosure.

The card body 2000 may have a groove 2000h and may include a first connection pad 2000P.

The fingerprint sensor package 1000′ may be inserted into the groove 2000h of the card body 2000. The fingerprint sensor package 1000 may be inserted into the groove 2000h so that the molding material 400 for molding the controller chip 200 and the passive component 300 may face the card body 2000.

The first connection pad 2000P may electrically connect the card body 2000 to the fingerprint sensor package 1000. A conductive adhesive member A2 may be disposed between the first connection pad 2000P of the card body 2000 and the second connection pad 124B of the fingerprint sensor package 1000. The conductive adhesive member A2 may be and/or may include an anisotropic conductive film (ACF), however, the present disclosure is not limited thereto.

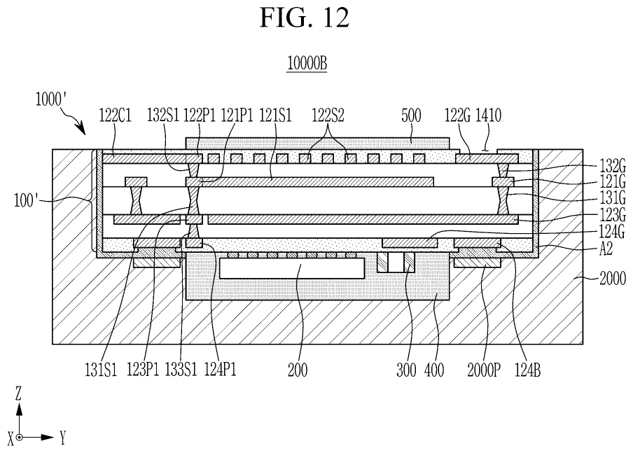

FIG. 12 is a cross-sectional view in the Y direction of a fingerprint authentication card, according to an embodiment.

In the fingerprint authentication card 10000B, the conductive adhesive member A2 may extend onto the side of the first substrate 100′ and may cover the exposed first connection pattern 122C1 and second connection pattern 122C2. The first connection pattern 122C1 and the second connection pattern 122C2 may be protected through the conductive adhesive member A2. Alternatively or additionally, the first connection pattern 122C1 and the second connection pattern 122C2 may be covered with a separate material that may be different from the conductive adhesive member A2, such as, but not limited to, an insulating adhesive member.

While the embodiments of the present disclosure have been described in detail, it is to be understood that the disclosure is not limited to the disclosed embodiments, but on the contrary, is intended to cover various modifications and equivalent arrangements included within the spirit and scope of the appended claims.

What is claimed is:

1. A fingerprint sensor package, comprising:
a first substrate comprising:
a first insulating layer;
a first conductive pattern layer;
a second conductive pattern layer spaced apart from the first conductive pattern layer by the first insulating layer; and
a first protective layer at least partially covering the second conductive pattern layer;
a controller chip on the first substrate; and
a molding material molding the controller chip,
wherein the first conductive pattern layer comprises a first sensing pattern,
wherein the second conductive pattern layer comprises:
a first test pad electrically coupled with the first sensing pattern;
a second sensing pattern intersecting the first sensing pattern on a plane; and
a second test pad electrically coupled with the second sensing pattern,
wherein the first conductive pattern layer is at a level between the second conductive pattern layer and the controller chip, and
wherein the first test pad and the second test pad are at least partially exposed through one or more first openings of the first protective layer.

2. The fingerprint sensor package of claim 1, wherein the first substrate comprises a central region and a peripheral region at least partially surrounding the central region,
wherein the first sensing pattern and the second sensing pattern are in the central region of the first substrate, and
wherein the first test pad and the second test pad are in the peripheral region of the first substrate.

3. The fingerprint sensor package of claim 2, wherein the first substrate further comprises:
a first via penetrating the first insulating layer in the central region and electrically coupling the first sensing pattern with the first test pad.

4. The fingerprint sensor package of claim 3, wherein the second conductive pattern layer further comprises:
a first pad in contact with the first via; and
a first connection pattern coupling the first pad with the first test pad, and
wherein the first connection pattern extends from the central region to the peripheral region.

5. The fingerprint sensor package of claim 2, wherein the second conductive pattern layer further comprises:
a second pad extending from the second sensing pattern; and
a second connection pattern coupling the second pad with the second test pad, and
wherein the second connection pattern extends from the central region to the peripheral region.

6. The fingerprint sensor package of claim 5, wherein the first conductive pattern layer further comprises a third pad, and
wherein the first substrate further comprises:
a second via penetrating the first insulating layer in the central region and coupling the second pad with the third pad.

7. The fingerprint sensor package of claim 1, wherein the first sensing pattern extends in a first direction,
wherein the first test pad extends in the first direction from the first sensing pattern on the plane,
wherein the second sensing pattern extends in a second direction intersecting the first direction on the plane, and
wherein the second test pad extends from the second sensing pattern in the second direction.

8. The fingerprint sensor package of claim 7, wherein the second conductive pattern layer further comprises:
one or more first ground patterns in a central region of the first substrate and at least partially exposed through the one or more first openings of the first protective layer.

9. The fingerprint sensor package of claim 8, wherein the one or more first ground patterns comprise a first ground pattern spaced apart from the first test pad in the first direction, and
wherein the second sensing pattern is between the first test pad and the first ground pattern spaced apart from the first test pad in the first direction.

10. The fingerprint sensor package of claim 8, wherein the one or more first ground patterns comprise a first ground pattern in at least one of corner regions of the central region of the first substrate.

11. The fingerprint sensor package of claim 8, wherein the first substrate further comprises:
a second insulating layer; and
a third conductive pattern layer spaced apart from the first conductive pattern layer by the second insulating layer, and
wherein the third conductive pattern layer comprises a second ground pattern electrically coupled with a first ground pattern of the one or more first ground patterns.

12. The fingerprint sensor package of claim 11, wherein the first substrate further comprises:
a third insulating layer;
a fourth conductive pattern layer spaced apart from the third conductive pattern layer by the third insulating layer; and
a second protective layer at least partially covering the fourth conductive pattern layer, and
wherein the fourth conductive pattern layer comprises a connection pad at least partially exposed through one or more second openings of the second protective layer.

13. The fingerprint sensor package of claim 1, further comprising:
a passive component spaced apart from the controller chip on the first substrate and molded with the molding material.

14. The fingerprint sensor package of claim 1, further comprising:
a coating layer on the first protective layer.

15. A fingerprint sensor package stacked structure, comprising:
a fingerprint sensor package; and
a second substrate on which the fingerprint sensor package is disposed and comprising a through hole,
wherein the fingerprint sensor package comprises:
a first substrate comprising a central region, a peripheral region at least partially surrounding the central region, a first insulating layer, a first conductive pattern layer and a second conductive pattern layer spaced apart from the first conductive pattern layer by the first insulating layer, and a protective layer at least partially covering the second conductive pattern layer;
a controller chip on the central region of the first substrate; and
a molding material molding the controller chip,
wherein the central region of the first substrate at least partially disposed on the through hole,
wherein the first conductive pattern layer comprises a first sensing pattern,
wherein the second conductive pattern layer comprises a first test pad electrically coupled with the first sensing pattern, a second sensing pattern intersecting the first sensing pattern on a plane, and a second test pad electrically coupled to the second sensing pattern,
wherein the first sensing pattern and the second sensing pattern are in the central region of the first substrate,
wherein the first test pad and the second test pad are in the peripheral region of the first substrate and face the second substrate, and
wherein the first test pad and the second test pad are at least partially exposed through one or more openings of the protective layer.

16. The fingerprint sensor package stacked structure of claim 15, further comprising:
an adhesive member between the first substrate and the second substrate,
wherein the adhesive member at least partially covers the first test pad and the second test pad.

17. A fingerprint authentication card, comprising:
a card body having a groove; and
a fingerprint sensor package, at least a portion of the fingerprint sensor package being within the groove,
wherein the fingerprint sensor package comprises:
a substrate comprising an insulating layer, a first conductive pattern layer and a second conductive pattern layer spaced apart from the first conductive pattern layer by the insulating layer, and a protective layer at least partially covering the second conductive pattern layer;
a controller chip on a first surface of the substrate; and
a molding material molding the controller chip,
wherein the first conductive pattern layer comprises a first sensing pattern,
wherein the second conductive pattern layer comprises a first connection pattern electrically coupled with the first sensing pattern, a second sensing pattern intersecting the first sensing pattern on a plane, and a second connection pattern electrically coupled with the second sensing pattern, and
wherein the first connection pattern and the second connection pattern are at least partially exposed to side surfaces of the substrate.

18. The fingerprint authentication card of claim 17, wherein the first connection pattern and the second connection pattern are at least partially exposed to different side surfaces of the substrate.

19. The fingerprint authentication card of claim 17, wherein the card body comprises a first connection pad,
wherein the fingerprint sensor package comprises a second connection pad positioned on the first surface of the substrate, and
wherein the fingerprint authentication card further comprises a conductive adhesive member between the first connection pad and the second connection pad.

20. The fingerprint authentication card of claim 19, wherein the conductive adhesive member extends onto a side surface of the substrate and at least partially covers the at least partially exposed first connection pattern and the second connection pattern.
